(19) United States
(12) Patent Application Publication
(10) Pub. No.: US 2026/0229374 A1
(43) Pub. Date: Aug. 6, 2026

(54) CHAIN CONTAINER REACTOR

(71) Applicant: UNISTS, Seoul (KR)

(72) Inventor: Myong Jin KWON, Gimpo-si (KR)

(21) Appl. No.: 19/045,691

(22) Filed: Feb. 5, 2025

(51) Int. Cl. G21C 3/04; G21C 5/14; G21C 19/10; G21C 19/19

(52) U.S. Cl. CPC G21C 3/04; G21C 5/14; G21C 19/10; G21C 19/19

(57) ABSTRACT

The present invention relates to a reactor utilizing chain-shaped moderators, nuclear fuels, and a container that houses them.

The reactor operates by having an outlet connecting the interior and exterior of the reactor, through which chain-shaped moderators or nuclear fuel are inserted or withdrawn. The device that is connected to the reactor's outlet and is used to store, insert, and withdraw the chain-shaped moderators or nuclear fuel is called the container.

### TECHNICAL FIELD

This invention relates to a reactor that uses a chain-shaped nuclear fuel, moderator, and one or more containers that house the nuclear fuel and the moderator.

### BACKGROUND TECHNOLOGY OF THE INVENTION

Nuclear power plants use nuclear fuels such as U235, U233, Pu239, TRU, etc. These fuels undergo fission, releasing neutrons. The neutrons released are absorbed by other nuclear fuel atoms, which then undergo fission again, causing a chain reaction. Nuclear power plants use heat released during this process as an energy source.

For a nuclear fuel atom to undergo fission inside a reactor, it must first absorb a neutron. However, not all neutrons that collide with the nucleus are absorbed. The probability of absorption varies depending on the speed of the neutrons and composition of the nucleus. This probability is quantified by the neutron capture cross-section. The larger the neutron capture cross-section, the higher the probability that a neutron will be absorbed by the nucleus of the nuclear fuel atom, which leads to more fission reactions.

FIG. 1 is a chart that shows the neutron capture cross-sections of popular nuclides for nuclear fuel. All nuclides depicted in FIG. 1 have larger neutron capture cross-sections when the neutrons are in a low-energy state. This means that thermal neutrons that have slower speed are more likely to be absorbed by the atomic nucleus of the nuclear fuel atoms. However, most neutrons emitted during fission are high-energy neutrons, averaging 2 MeV of energy. When these high-speed neutrons collide with nuclear fuel atoms, they are not easily absorbed, making it less favorable for sustaining the chain reaction of nuclear fission.

To increase the probability of neutron absorption by nuclear fuel atoms and promote the chain reaction, a moderator is used to convert high-energy neutrons to thermal neutrons by slowing down their speed. If a moderator is used, the speed of the neutrons decreases, promoting the fission of nuclear fuel, making it possible to initiate a chain reaction with lower concentrations of nuclear fuel.

FIG. 2 shows the moderation of major materials. The order of moderation efficiency is as follows: Light water>Heavy water>He>Be>C (Graphite).

In a light-water reactor, the reactor core operates at very high pressure (150-160 atm) to prevent the water from boiling. In contrast, molten-salt reactors and sodium-cooled reactors operate at much lower pressure (1 atm), which offers safety advantages, lower costs for pressure vessel construction, and the ability to raise the primary coolant temperature significantly, producing high-temperature steam (350°C-600°C) for better thermal efficiency.

The lifespan of a nuclear reactor is typically between 30 and 60 years, but most internal components and materials have shorter lifespans and need to be replaced periodically during operation. Among these, nuclear fuel and moderators generally need to be replaced every 1 to 4 years, requiring the reactor to be shut down and the core to be opened for maintenance. This is a highly dangerous operation with the possibility of leakage of radioactive materials, and the operation of the reactor must be stopped during this period, which negatively affects the economical operation of the reactor.

### PROBLEMS TO BE SOLVED BY THE INVENTION

this invention provides a means for replacing nuclear fuel and moderator without having to stop and open the reactor, enabling continuous power generation without risky operations previously described.

### SOLUTION TO THE PROBLEM

To achieve this, the invention proposes making nuclear fuel and moderators in the shape of chains, which can be inserted or withdrawn through an outlet of the reactor. A container is provided to store and manage the insertion and extraction of the chains.

### EFFECTS OF THE INVENTION

With the reactor described in this invention, the nuclear fuel and moderators can be replaced without opening the reactor core and engaging in dangerous work. Moreover, the reactor does not need to be shut down, allowing for continuous power generation.

### BRIEF DESCRIPTION OF THE DRAWINGS

FIG. 1: A graph showing the Neutron capture cross-sections of key nuclides.

FIG. 2: A table showing the neutron moderation capabilities of various materials.

FIG. 3: A structural diagram of a reactor using chain-shaped nuclear fuel and moderators.

FIG. 4: A diagram of a reactor using multiple chains.

FIG. 5: A conceptual diagram for long-term reactor operation using chain nuclear fuel.

FIG. 6: A diagram of hybrid chain nuclear fuel combining U235 and Th232.

FIG. 7: Material of the vessel used for chain storage.

FIG. 8: Various chain shapes that may be used in the reactor.

FIG. 9: A diagram illustrating the process of manufacturing graphite moderator chains.

FIG. 10: A diagram showing the hybrid structure of nuclear fuel and graphite moderator chains.

FIG. 11: A diagram showing the shape of the chain to prevent twisting.

FIG. 12: A diagram of a reactor with one chain, container, and vessel.

FIG. 13: A diagram of the internal structure of a container designed for storing, inserting, and withdrawing chains.

FIG. 14: A diagram of a reactor with a 4-chain, 4-vessel structure.

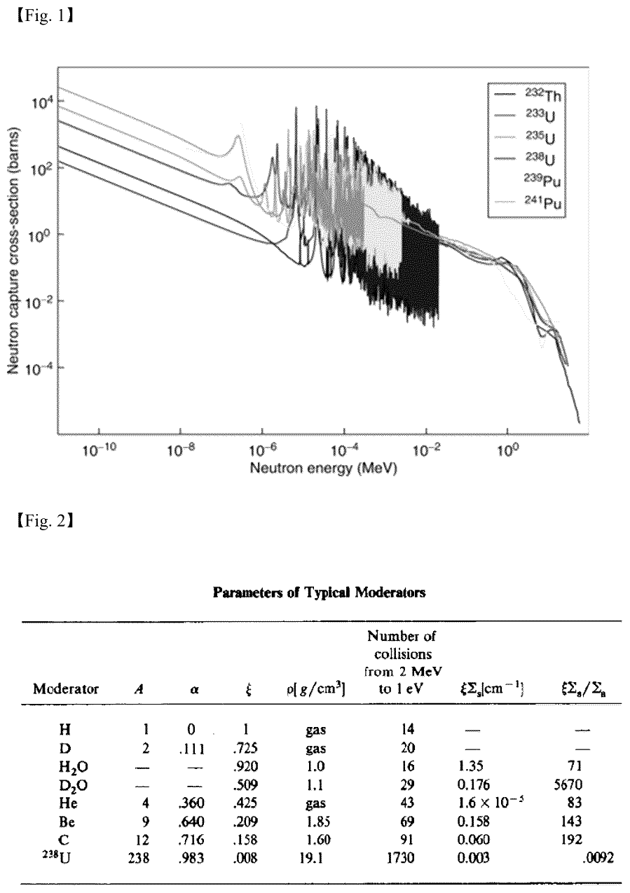

### DETAILED DESCRIPTION OF THE INVENTION

This invention simplifies the replacement of nuclear fuel and moderators by manufacturing them in the shape of chains. While it is possible to create other reactor components, such as control devices and reflectors, in chain form, these components generally have longer lifespans and doing so is less beneficial.

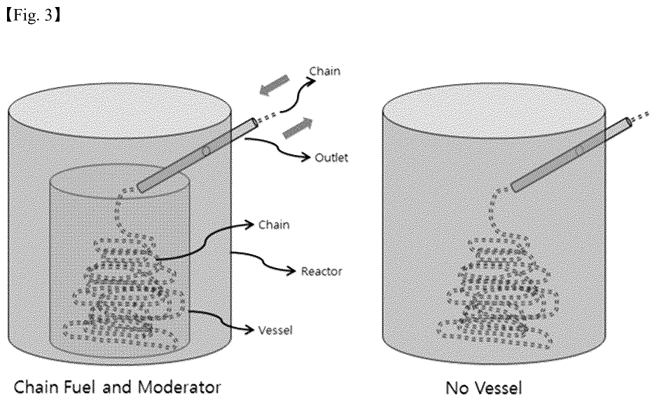

FIG. 3 shows a reactor structure using chain-shaped nuclear fuel and moderators. An outlet connected to the outside of the reactor is located at the upper side of the reactor. The chains are inserted or withdrawn through this outlet. The chains can either be stacked directly at the bottom of the reactor without using an internal vessel, or they can be stored inside a vessel within the reactor.

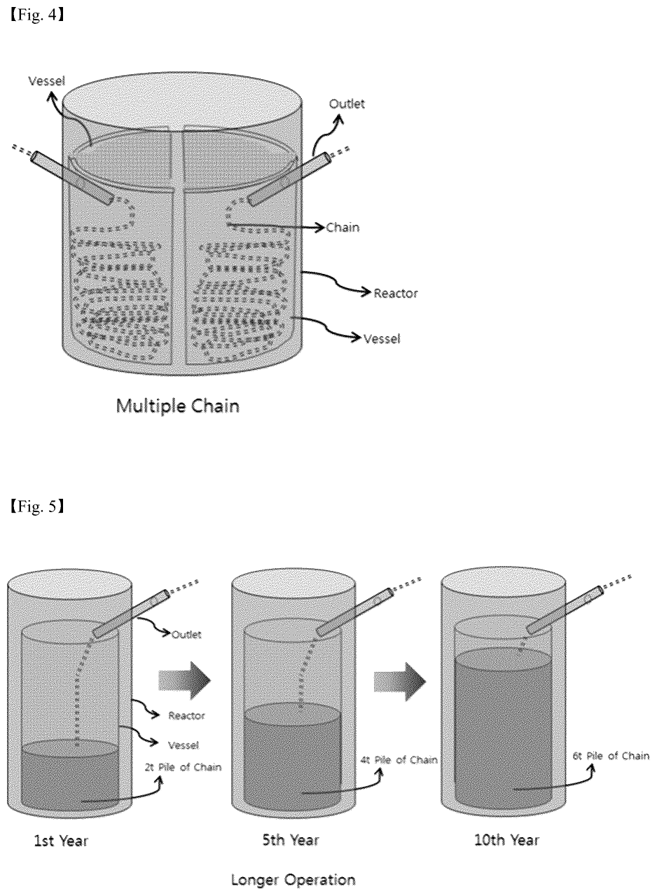

FIG. 4 shows a reactor using multiple chains. Two outlets allow for the insertion and withdrawal of two chains, one from each, with two vessels inside the reactor. Using multiple chains and vessels allows for more precise placement of the chains inside the reactor, and in the events of emergencies such as natural disasters, chains can be retrieved more quickly. Additionally, depending on the design, nuclear fuel and moderators can be made into multiple chains.

By using an outlet to insert and withdraw chains, there is no need to open the reactor core, thereby improving the safety of the replacement process of nuclear fuel and moderators. Moreover, the reactor can continue to operate while the fuel and moderator are being replaced.

The main purpose of this invention is to provide a safe and convenient way to install, remove, and replace nuclear fuel and moderators. Furthermore, it allows for partial insertion of nuclear fuel and moderators, which can be used for power control or long-term operation.

For example, if the amount of moderator in a design is 2 tons, a chain of 2.5 tons can be prepared, with the internal vessel also designed to accommodate 2.5 tons. In a breeder reactor, nuclear fuel may proliferate during operation, leading to an increase in output power generation. In such a case, only 1.8 tons of moderator may be inserted to reduce the output. On the other hand, in a typical burner reactor, as fission progresses, the amount of nuclear fuel decreases while fission products increase, causing the output power to gradually decrease. By increasing the amount of moderator, the neutrons' speed can be further reduced, causing the output power to increase again. Similarly, the amount of chain nuclear fuel can be adjusted to control the output. Therefore, control rods and similar devices are not necessary, and the reactor's criticality and output can be controlled by adjusting the amounts of nuclear fuel and moderators according to the operating needs.

FIG. 5 illustrates a concept for long-term operation of a reactor using chain nuclear fuel. In applications such as ships, which require long-term operation without fuel replacement, if the appropriate amount of nuclear fuel for maintaining criticality is 2 tons, the reactor core may be designed to hold 6 tons, and 6 tons of chain nuclear fuel may be prepared. Of them, Only 2 tons of fuel may be initially inserted into the reactor through the outlet. As the fuel is consumed and the output decreases, additional chain of nuclear fuel may be continuously added. In theory, This allows for approximately three times longer continuous operation time compared to simply burning 2 tons of fuel. The chain nuclear fuel can be stored inside one or more vessels, or it can be directly loaded into the reactor core.

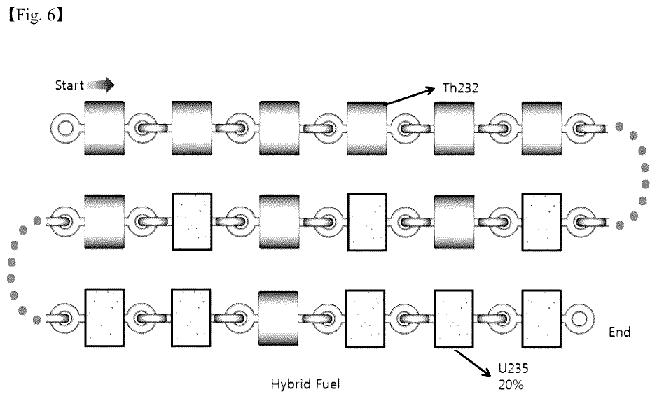

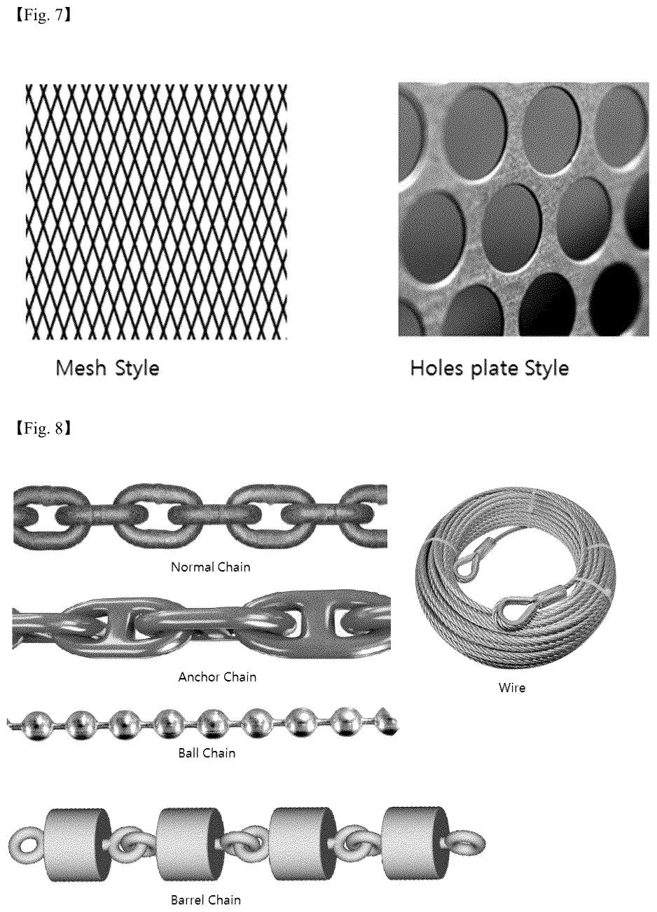

FIG. 6 shows a diagram of a hybrid chain nuclear fuel combining U235 and Th232. Long-term operation demonstrated by FIG. 5 may be achieved using a single type of nuclear fuel, but by utilizing the thorium breeding cycle and combining U235 with Th232, the operational period can be extended. A barrel containing 20% enriched U235 and Th232 is mixed to produce a chain. Initially, U235 undergoes fission, and some of the neutrons released are absorbed by Th232, which transforms into Pa 233. This then decays into U233 with a half-life of 27 days. The U233 produced makes for a good nuclear fuel. After most of the U235 is consumed during fission, U233 becomes the main fission material. Based on past examples, breeding as much U233 as the amount of U235 depleted is difficult, because breeding Th232 is quite difficult. However, by continuously supplying U235 through the chain of nuclear fuel, criticality of the reactor can be maintained, making it easier to utilize the Th232-U233 fuel cycle. This also allows for longer continuous operation than using U235 alone for fission. For example, the amount of fuel that is made available by breeding Th232 is theoretically five times greater than that included in 20% enriched U235. The initial fissioning element does not have to be U235; other fissile materials such as U233, Pu239, TRU, and MOX may also be used. Additionally, to facilitate breeding, U238 can be used instead of Th232 to implement the U238-Pu239 cycle, but this requires a fast reactor design since thermal neutrons cannot be used.

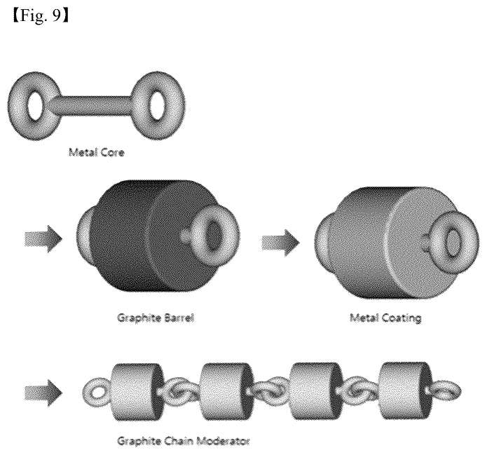

FIG. 7 shows the material of the reactor's internal vessel. The vessel is designed to secure the space inside the reactor and position the chains as needed. The chains must allow for the smooth circulation of the primary coolant, (such as molten salt or sodium), and they must not get caught inside the vessel. Therefore, a detailed mesh or holes plate structure is preferred to ensure proper flow and prevent obstruction.

FIG. 8 shows various shapes of chains. Chains such as standard chains, anchor chains used on ships, ball chains commonly used in jewelry, flexible wire-shaped chains, and barrel chains capable of holding heavy objects may be used. Among these, The barrel chain shape is preferred for the ease of nuclear fuel and moderator processing. other shapes may also be used if they maintain strength and durability, and are not easily tangled.

FIG. 9 shows an example of the process for manufacturing graphite moderator chains. The metal core must support the primary material and withstand a certain amount of tensile force and wear. Materials such as zirconium (Zr) or Hastelloy, which have strength and resistance to corrosion from neutrons and the primary coolant must be used. Graphite is compressed and bonded to the metal core, and a metal coating or cladding is applied to prevent wear or breakage. The chain is then formed by connecting the products to the desired length.

The chain must be designed with a higher specific gravity than the coolant so that it sinks effectively within the reactor. In sodium-cooled reactors, the density of sodium (0.968) is less than that of graphite (greater than 1.7), so graphite will naturally sink. However, in molten-salt reactors, the primary coolant, molten salt, typically has a density ranging from 2.1 to 2.8, meaning if the percentage of graphite in the chain is too high, the chain may float on the coolant. To solve this, the metal ratio (metal core and outer shell) must be increased to raise the overall density above 3 to ensure that the chain remains stable inside the vessel.

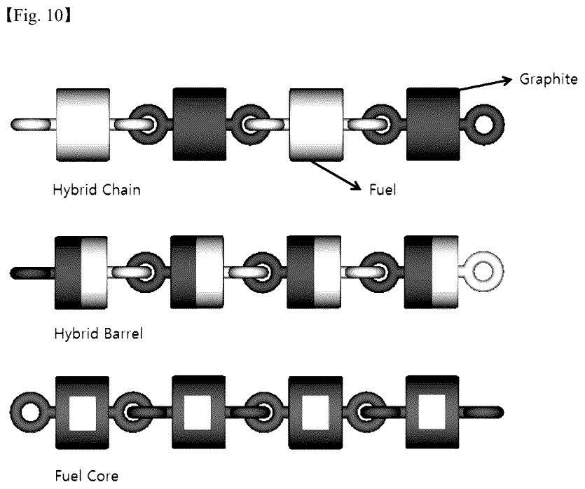

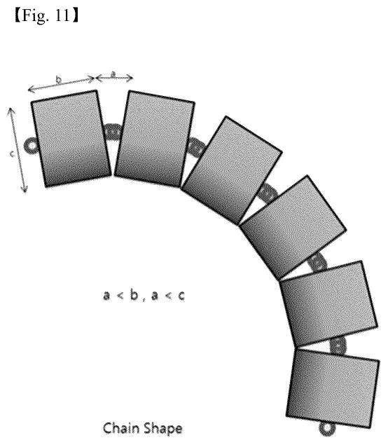

FIG. 10 illustrates the shape of a hybrid chain that combines nuclear fuel and moderators. Although The nuclear fuel and moderator can be manufactured as separate chains and placed in individual vessels, both can be integrated into a single chain, depending on the need. The closer the nuclear fuel and moderator are together, the more fission will occur, allowing for easier attainment of criticality.

The nuclear fuel and moderator can be arranged alternately along the chain, or each can be placed in a divided section within a single barrel. Another approach, used in pebble-bed reactors (HTR), is to place the nuclear fuel core inside the moderator.

In FIGS. 9 and 10, graphite is indicated as the moderator because most solid moderators used today are graphite. However, this concept can also be applied to other solid moderators such as beryllium oxide (BeO).

FIG. 11 shows a design of the chain shape to prevent twisting. If the dimensions of the barrel's width, height, and the connector do not meet the required conditions, the chain may become tangled or stuck inside the reactor or windlass. The width (a) of the central connector must be smaller than both the width (b) and height (c) of the barrel (a<b, a<c). For safety, it is preferable to satisfy the conditions: 2a<b and 3a<c. When these conditions are met, the maximum angle between two barrels is approximately 20°. Therefore, when 9 barrels are connected, the chain can be rotated in the opposite direction (180°). Furthermore, to maintain proper curvature inside the vessel and ensure stable storage, the vessel's curvature must be flatter than the rotation radius of the 9 barrels, ideally double the radius for stability. For a reactor vessel with a cylindrical radius of 1 meter, the design may vary, but the barrel width (b) should be approximately 12.5 cm or less.

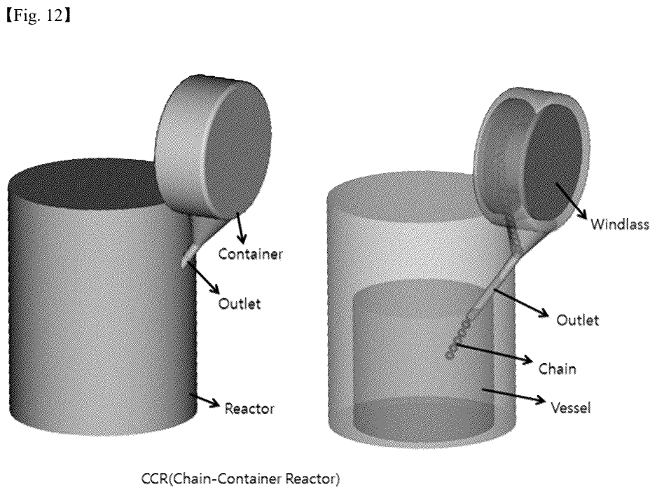

FIG. 12 shows a reactor structure with one chain, container, and vessel. An outlet is installed on the upper side of the reactor, and the container is fixed to the reactor's side. The location of the outlet may vary depending on the design. The container is located outside the reactor and can store, insert, and withdraw chains. Inside the container, a windlass is installed with a motor that allows the chain to be pulled up.

The reactor, designed to store, insert, and withdraw chain-shaped nuclear fuel or moderator through a container, is a Chain-Container Reactor (CCR).

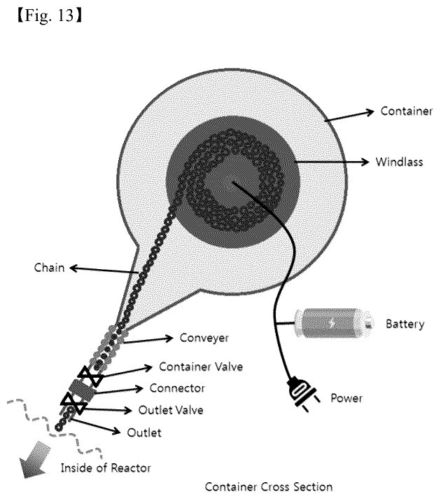

FIG. 13 shows the internal structure of the container designed for storing, inserting, and withdrawing the chains. The container is connected to the reactor via the outlet, and a connector is used to seal the connection to prevent gas leakage. Valves are present on both the container and outlet sides. Before separating the container and outlet, both valves must be closed to prevent leakage of gases or other materials.

Additionally, a conveyor is installed just inside the container valve. The conveyor has a motor that assists in inserting and withdrawing the chains without them getting stuck. If the conveyor is absent, the chains could get stuck when entering the narrow outlet. Thus, the conveyor should drive the chain down when it is inserted to the reactor, and the windlass should pull the chain up when retrieving it from the reactor to keep it taut and prevent tangling. To prevent unintentional chain insertion accidents (such as windlass failure or chain breakage), the conveyor can act as a brake, or a separate braking system can be installed.

The procedure for inserting chains into the reactor is as follows:
Transfer of the container
Attaching the container to the reactor
Connector coupling
Opening both valves
Insertion of the chain through conveyor drive
The procedure for retrieving chains from the reactor is as follows:
Chain retrieval using windlass rotation
Locking both valves
Disconnection of the connector
Removal of the container
Transfer of the container

By following these steps, nuclear fuel and moderators can be inserted or withdrawn without having to open the reactor core. Furthermore, the seal is maintained throughout the process, preventing any radioactive material from leaking. The container can also be shipped from the fuel manufacturer to the nuclear power plant without the need for a separate fuel container.

The windlass and conveyor are powered by electricity. The motor driving the container does not consume a significant amount of power, so a small battery can be attached to keep the system running in case of a power outage at the power plant.

For example, the energy required to lift 500 kg of graphite moderator to a height of 2 meters is calculated as 9.8×500×2=9800 J. The average capacity of a smartphone battery in 2020 is about 15 Wh, or 15×3600=54000 J. Therefore, with 100% energy efficiency, a smartphone battery can perform emergency retrieval for approximately 5 times.

In the event of a natural disaster that causes a power failure in the reactor, the nuclear fuel and moderator inside the reactor can be returned to the container. This reduces the likelihood of continuing fission, helping to avoid catastrophic situations like core meltdown.

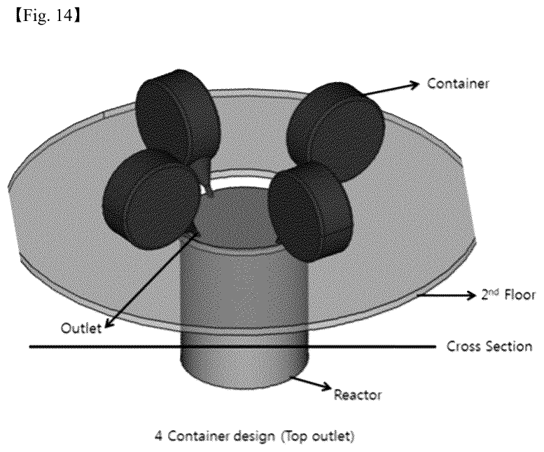

FIG. 14 shows a reactor design with a 4-chain, 4-vessel structure. When there are more containers, chains can be inserted and withdrawn simultaneously, speeding up the operation. Moreover, in case of an emergency, the chains must be quickly withdrawn from the reactor to stop the reactor. With multiple containers, even if one or two containers fail, the remaining fuel and moderators will not allow the reactor to reach criticality, ensuring that the reactor can be safely shut down.

Unlike FIG. 12, FIG. 14 demonstrates a design where the containers are not attached to the reactor, but are installed on a two-story structure. A steel or concrete structure is used to build the two-story setup to ensure structural stability. The chain's outlet is positioned on the top of the reactor instead of the side. Depending on the application, the number of containers can vary, and the number of outlets and internal vessels will depend on the number of containers. Distributing nuclear fuel across multiple containers reduces risk of danger in case of an accident.

When it becomes time for nuclear fuel replacement, in the case where one container is attached to the vessel via one outlet, the replacement process is as follows:
Arrival of new container
Withdrawal of old chain
Locking of old valve
Disconnection of old connector
Removal of old container
Attachment of new container
Coupling of new connector
Opening of new valve
Insertion of new chain
Transfer of old container

This process allows for continuous reactor operation while replacing nuclear fuel, though reactor output will decrease during the replacement. Reducing the time between these steps is crucial for uniform operation. With the above process, a total of 6 steps are required between steps 2 (withdrawal of old chain) and 9 (insertion of new chain).

However, in the double-container method, there is an extra outlet, allowing for the attachment of an additional container while the old one is still attached. The process is as follows:
Arrival of new container
Attachment of new container
Coupling of new connector
Withdrawal of old chain
Locking of old valve
Opening of new valve
Insertion of new chain
Disconnection of old connector
Removal of old container
Transfer of old container

This method requires only two steps between the withdrawal of the old chain and the insertion of the new chain (steps 4 and 7). The valve operation is quick, minimizing the duration the reactor's output is reduced.

1: A reactor, comprising: an outlet connected from the interior of the reactor to the exterior, wherein a container is connected to the reactor via the outlet, and the container stores nuclear fuel or moderator in the form of chains, and wherein the nuclear fuel or moderator is inserted into or withdrawn from the reactor through the outlet, operating by this method.

2: The reactor of claim 1, wherein a vessel is provided inside the reactor, and the chains are inserted into the reactor by loading them into the vessel.

3: The reactor of claim 1, wherein a plurality of vessels surrounding the reactor core are used, with each vessel inserting and withdrawing chain-shaped nuclear fuel or moderators.

4: The reactor of claim 1, wherein the nuclear fuel and moderator are combined into a single hybrid chain for operation.

5: The reactor of claim 1, wherein an amount of chain nuclear fuel exceeding the reactor's critical mass is loaded into the container, and only the amount required to maintain criticality is initially inserted into the reactor, and additional chain nuclear fuel is continuously inserted as the fuel is consumed, enabling long-term continuous operation.
